(19) United States
(12) Patent Application Publication
(10) Pub. No.: US 2024/0253227 A1
(43) Pub. Date: Aug. 1, 2024

(54) Method For Deciding Valid Working Spot In Robotic Process

(71) Applicant: MakinaRocks Co., Ltd., Seoul (KR)

(72) Inventors: Jeyeol LEE, Seoul (KR); Goncalves Rocha YURI, Seoul (KR); Yu Jeong JEONG, Seoul (KR)

(73) Assignee: MakinaRocks Co., Ltd., Seoul (KR)

(21) Appl. No.: 18/426,894

(22) Filed: Jan. 30, 2024

(30) Foreign Application Priority Data
Jan. 30, 2023 (KR) 10-2023-0011389

(51) Int. Cl. B25J 9/16; G05B 19/042

(52) U.S. Cl. CPC B25J 9/1664; G05B 19/042

(57) ABSTRACT

Disclosed is a method of determining a valid working spot of a robot, the method performed by a computing device, the method including: identifying a working spot; determining whether a robot is capable of taking at least one pose for working the working spot; when the robot is capable of taking at least one pose for working the working spot, determining the working spot as a valid working spot of the robot; and generating a search space for distributing working spots based on the valid working spot of the robot.

### CROSS-REFERENCE TO RELATED APPLICATIONS

This application claims priority to and the benefit of Korean Patent Application No. 10-2023-0011389 filed in the Korean Intellectual Property Office on Jan. 30, 2023, the entire contents of which are incorporated herein by reference.

### TECHNICAL FIELD

The present disclosure relates to a method of determining a valid working spot used in a program of a robotic process, and more specifically, to a method of determining a valid working spot (for example, a working spot at which a specific robot may perform work) and efficiently determining a search space for distributing working spots.

### BACKGROUND ART

An Off Line Program (OLP) refers to designing a program for a robotic process in a simulation, testing the program, and then applying the generated program to a real robot.

Today, OLP technology allows designers to design the behavior of a robot in a virtual space, rather than designing the behavior of the robot while directly controlling the robot.

However, when a designer designs a program, the search space grows exponentially depending on the size of the process, such as the number of robot joints, number of robots, obstacles, the number of working spots, and number of stations, thereby making the OLP for large-scale processes difficult to optimize in terms of time and cost.

Therefore, there is a need in the art for a solution that optimally determines the searching space for OLP to solve the problems encountered during the generation of the robotic process program.

On the other hand, the present disclosure has been derived based on at least the technical background discussed above, but the technical problem or purpose of the present disclosure is not limited to solving the problems or disadvantages discussed above. That is, the present disclosure may cover various technical issues related to the content to be described below in addition to the technical issues discussed above.

### SUMMARY OF THE INVENTION

The present disclosure is conceived in response to the background art, and has been made in an effort to provide a solution for efficiently determining a search space for Off Line Programming (OLP).

On the other hand, the technical problem to be achieved by the present disclosure is not limited to the technical problem mentioned above, and various technical problems may be included within the range obvious to those skilled in the art from the content to be described below.

An exemplary embodiment of the present disclosure for solving the foregoing problem provides a method of determining a valid working spot of a robot, the method performed by a computing device, the method including: identifying a working spot; determining whether a robot is capable of taking at least one pose for working the working spot; when the robot is capable of taking at least one pose for working the working spot, determining the working spot as a valid working spot of the robot; and generating a search space for distributing working spots based on the valid working spot of the robot.

In the exemplary embodiment, the identifying of the working spot may include: identifying location information of the working spot; and identifying work direction information of the working spot.

In the exemplary embodiment, the determining of whether the robot is capable of taking at least one pose for working the working spot may include: identifying a pose in which the robot is capable of positioning a working part of the robot at the working spot; checking whether the identified pose causes a collision; and when the identified pose causes a collision, searching for a new pose based on the identified pose.

In the exemplary embodiment, the searching for the new pose based on the identified pose may include at least one of: performing an Inverse Kinematics (IK) computation while rotating a work part of the robot about a specific axis direction of the robot; performing an IK computation while translationally moving a working part of the robot in a specific axis direction of the robot; or performing an IK computation while changing a working direction of a working part of the robot.

In the exemplary embodiment, the determining of the working spot as the valid working spot of the robot when the robot is capable of taking at least one pose for working the working spot may include determining at least one candidate working pose associated with the valid working spot based on the at least one pose.

In the exemplary embodiment, the determining of at least one candidate working pose associated with the valid working spot may include determining equal to or fewer than a predetermined number of candidate working poses by using at least one of: distance information to a center of mass of a work target; angle information between an axis of the work target and an axis of the robot; or distance information between a center of mass of the robot and a mesh vertex of the work target.

In the exemplary embodiment, the generating of the search space for distributing the working spots may include generating a search space for distributing working spots, based on the valid working spot of the robot and the at least one candidate working pose.

In the exemplary embodiment, the generating of the search space for distributing the working spots, based on the valid working spot of the robot and the at least one candidate working pose may include: excluding working spots that are not valid working spots of the robot among total working spots from the search space associated with the robot; and limiting the at least one candidate working pose to a predetermined number or less.

In the exemplary embodiment, the determining of the working spot as the valid working spot of the robot when the robot is capable of taking at least one pose for working the working spot may include excluding a specific working spot from the valid working spot when the robot is predicted to be unable to enter the working spot, although the robot is capable of taking at least one pose for working the working spot.

In the exemplary embodiment, the predicting of whether the robot is able to enter the working spot” may be performed based on approximating a movement of the robot to a movement of a work part of the robot.

Another exemplary embodiment of the present disclosure for solving the foregoing problem provides a computer program stored in a computer-readable storage medium, the computer program causing at least one processor to perform operations to determine a valid working spot of a robot, the operations including: identifying a working spot; determining whether a robot is capable of taking at least one pose for working the working spot; when the robot is capable of taking at least one pose for working the working spot, determining the working spot as a valid working spot of the robot; and generating a search space for distributing working spots based on the valid working spot of the robot.

Still another exemplary embodiment of the present disclosure for solving the foregoing problem provides a computing device, including: at least one processor; and a memory, in which the at least one processor is configured to identify a working spot, determine whether a robot is capable of taking at least one pose for working the working spot, determine the working spot as a valid working spot of the robot when the robot is capable of taking at least one pose for working the working spot, and generate a search space for distributing working spots based on the valid working spot of the robot.

The present disclosure may provide a solution for efficiently determining the search space for Off Line Programming (OLP). For example, the present disclosure may transform the problem of distributing working spots, which is a Non-deterministic Polynomial Hard (NP Hard) problem, into a “problem that can be optimized in a feasible time” by determining the valid working spots of each robot based on the pose of each robot, and reducing the search space for distributing working spots (distributing working spots between the robots) based on the determined valid working spots.

On the other hand, the effect of the present disclosure is not limited to the above-mentioned effects, and various effects may be included within the range apparent to those skilled in the art from the content to be described below.

### BRIEF DESCRIPTION OF THE DRAWINGS

FIG. 1 is a block diagram of a computing device performing operations according to an exemplary embodiment of the present disclosure.

FIG. 2 is a schematic diagram illustrating a neural network according to the present disclosure.

FIG. 3 is a flowchart illustrating a schematic flow of a method of the present disclosure according to an exemplary embodiment of the present disclosure.

FIG. 4 is a schematic diagram illustrating distance information to a center of gravity of a work target according to the exemplary embodiment of the present disclosure.

FIG. 5 is a schematic diagram illustrating angle information between an axis of a work target and an axis of the robot according to the exemplary embodiment of the present disclosure.

FIG. 6 is a schematic diagram illustrating distance information between a center of gravity of the robot and a mesh vertex of the work target according to the exemplary embodiment of the present disclosure.

FIG. 7 is a schematic diagram illustrating partial equipment of a robot according to the exemplary embodiment of the present disclosure.

FIG. 8 is a simple and general schematic diagram for an example of a computing environment in which exemplary embodiments of the present disclosure are implementable.

### DETAILED DESCRIPTION

Various exemplary embodiments will now be described with reference to drawings. In the present specification, various descriptions are presented to provide appreciation of the present disclosure. However, it is apparent that the exemplary embodiments can be executed without the specific description.

“Component”, “module”, “system”, and the like which are terms used in the specification refer to a computer-related entity, hardware, firmware, software, and a combination of the software and the hardware, or execution of the software. For example, the component may be a processing procedure executed on a processor, the processor, an object, an execution thread, a program, and/or a computer, but is not limited thereto. For example, both an application executed in a computing device and the computing device may be the components.

One or more components may reside within the processor and/or a thread of execution. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

It should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

The term “at least one of A or B” should be interpreted to mean “a case including only A”, “a case including only B”, and “a case in which A and B are combined”.

Those skilled in the art need to recognize that various illustrative logical blocks, configurations, modules, circuits, means, logic, and algorithm steps described in connection with the exemplary embodiments disclosed herein may be additionally implemented as electronic hardware, computer software, or combinations of both sides. To clearly illustrate the interchangeability of hardware and software, various illustrative components, blocks, configurations, means, logic, modules, circuits, and steps have been described above generally In terms of their functionalities. Whether the functionalities are implemented as the hardware or software depends on a specific application and design restrictions given to an entire system. Skilled artisans may implement the described functionalities in various ways for each particular application. However, such implementation decisions should not be interpreted as causing a departure from the scope of the present disclosure.

The description of the presented exemplary embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein.

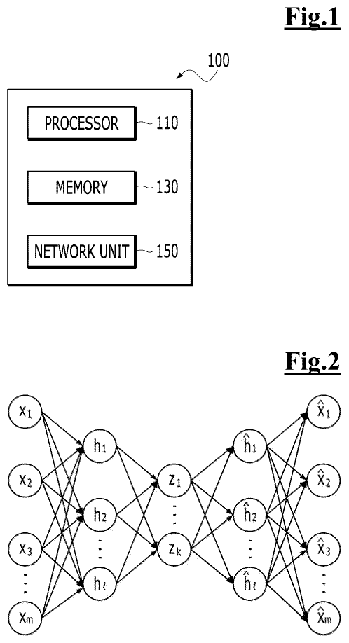

A configuration of the computing device 100 illustrated in FIG. 1 is only an example shown through simplification. In an exemplary embodiment of the present disclosure, the computing device 100 may include other components for performing a computing environment of the computing device 100 and only some of the disclosed components may constitute the computing device 100.

The computing device 100 may include a processor 110, a memory 130, and a network unit 150.

The processor 110 may be constituted by one or more cores and may include processors for data analysis and deep learning, which include a central processing unit (CPU), a general purpose graphics processing unit (GPGPU), a tensor processing unit (TPU), and the like of the computing device. The processor 110 may read a computer program stored in the memory 130 to perform data processing for machine learning according to an exemplary embodiment of the present disclosure. According to an exemplary embodiment of the present disclosure, the processor 110 may perform a calculation for training the neural network. At least one of the CPU, GPGPU, and TPU of the processor 110 may process training of a network function. For example, both the CPU and the GPGPU may process the training of the network function and data classification using the network function. Further, in an exemplary embodiment of the present disclosure, processors of a plurality of computing devices may be used together to process the training of the network function and the data classification using the network function. Further, the computer program executed in the computing device according to an exemplary embodiment of the present disclosure may be a CPU, GPGPU, or TPU executable program.

According to an exemplary embodiment of the present disclosure, the memory 130 can store information of any form generated or determined by the processor 110 and information of any form received by the network unit 150.

According to an exemplary embodiment of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the present disclosure is not limited thereto.

The network unit 150 according to an exemplary embodiment of the present disclosure may use various wired communication systems such as public switched telephone network (PSTN), x digital subscriber line (xDSL), rate adaptive DSL (RADSL), multi rate DSL (MDSL), very high speed DSL (VDSL), universal asymmetric DSL (UADSL), high bit rate DSL (HDSL), and local area network (LAN).

The network unit 150 presented in the present disclosure may use various wireless communication systems such as code division multi access (CDMA), time division multi access (TDMA), frequency division multi access (FDMA), orthogonal frequency division multi access (OFDMA), single carrier-FDMA (SC-FDMA), and other systems.

In the present disclosure, the network unit 150 may be configured regardless of communication modes such as wired and wireless modes and constituted by various communication networks including a personal area network (PAN), a wide area network (WAN), and the like. Further, the network may be known World Wide Web (WWW) and may adopt a wireless transmission technology used for short-distance communication, such as infrared data association (IrDA) or Bluetooth. The techniques described in the present disclosure may also be used in other networks mentioned above.

The reinforcement learning method of the present disclosure may use simulation models and reinforcement learning agents. Here, the simulation model is the entity that returns state information and rewards, and the reinforcement learning agent is the entity that determines behavior based on the state information and rewards. In the present disclosure, the contextual information may include contextual information at the current time and contextual information at the next time. Contextual information at the current time and contextual information at the next time may be categorized according to the time at which the contextual information was obtained. For example, based on the sequence in which the contextual information is generated, time points may be categorized as “t, t+1 t+2, t+3,” where “t, t+1 t+2, t+3” may be 1 second, 10 seconds, or 1 minute intervals. Specifically, a reinforcement learning agent according to the present disclosure may be trained based on at least one episode. In the present disclosure, the term “episode” may be used to mean a sequence of data having a sequence of order. An episode may be a dataset consisting of a plurality of E-tuples of data containing E elements (where E is a natural number equal to or greater than 1). The plurality of E-tuples of data included in the episode may have a sequence of orders. As an example of E-tuple of data, when E is ‘4’, each of 4-tuple data may include contextual information at the current time, a control action at the current time, a reward at the current time, and contextual information at the current time as elements. As another example of E-tuple of data, when E is ‘5’, each of 5-tuple data may include contextual information at the current time, a control action at the current time, a reward at the current time, contextual information at the next time, and a control action at the next time as elements.

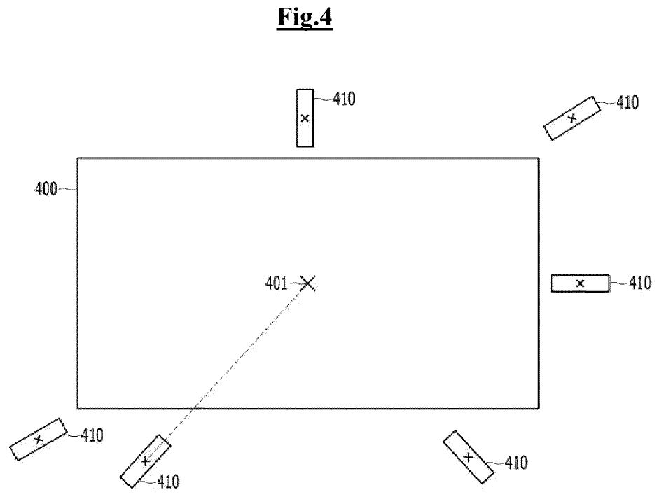

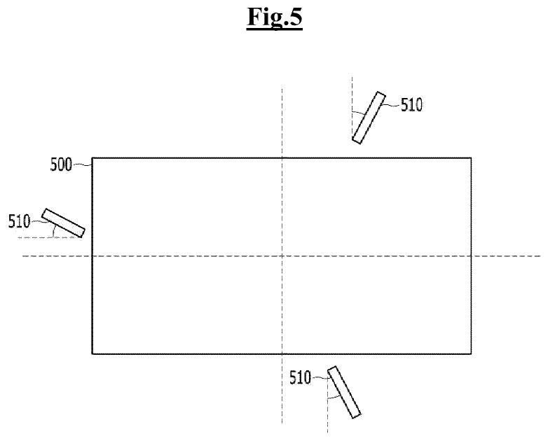

The process of the processor 110 performing reinforcement learning according to the present disclosure may include correcting a weight or a deviation value of each node of a neural network included in the reinforcement learning agent. The operation of correcting the weight or the deviation value of each node of a neural network included in the reinforcement learning agent may be performed by the processor 110 in the same or similar manner as the backpropagation technique for the neural network described with reference to FIG. 4. For example, when the reward (Rₜ) included in the training data at a predetermined time t is a positive number, the processor 110 may adjust the weight or a deviation value of one or more nodes included in the reinforcement learning agent such that the control behavior (Aₜ) at the predetermined time t included in the training data is reinforced. In this case, the one or more nodes included in the reinforcement learning control model may be nodes that were involved in determining the control action (Aₜ) after the reinforcement learning control model received the contextual information (Sₜ) included in the training data for the predetermined time t as input.

On the other hand, the reinforcement learning agent may determine a behavior on each state information in such a way that the cumulative value of the reward (that is, the return) is maximized. The method of determining the behavior by the reinforcement learning agent may be based on at least one of, for example, a value-based behavior determination method, a policy-based behavior determination method, or a behavior determination method based on both values and policies. The value-based behavior determination method determines the behavior that gives the highest value in each state based on a value function. Examples of the value-based behavior determination methods include Q-learning and Deep Q-Network (DQN). The policy-based behavior determination method is a method of determining behavior based on a final return and policy function without a value function. Examples of policy-based behavior determination method include the policy gradient technique. The behavior determination method based on both values and policies is a method of determining behavior of a reinforcement learning agent by learning in such a way that when the policy function determines the behavior, the value function evaluates the behavior. The behavior determination method based on both values and policies may include, for example, actor-critic algorithms, soft actor-critic algorithms, A2C algorithms, and A3C algorithms.

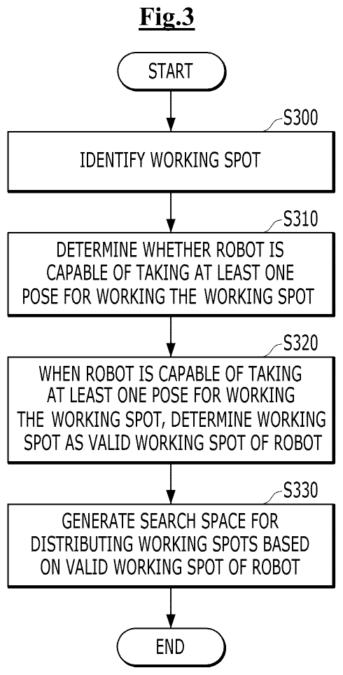

FIG. 2 is a conceptual view illustrating a neural network according to an exemplary embodiment of the present disclosure.

Throughout the present specification, a computation model, the neural network, a network function, and the neural network may be used as the same meaning. The neural network may be generally constituted by an aggregate of calculation units which are mutually connected to each other, which may be called nodes. The nodes may also be called neurons. The neural network is configured to include one or more nodes. The nodes (alternatively, neurons) constituting the neural networks may be connected to each other by one or more links.

In the neural network, one or more nodes connected through the link may relatively form the relationship between an input node and an output node. Concepts of the input node and the output node are relative and a predetermined node which has the output node relationship with respect to one node may have the input node relationship in the relationship with another node and vice versa. As described above, the relationship of the input node to the output node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable and the weight is variable by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form a relationship of the input node and output node in the neural network. A characteristic of the neural network may be determined according to the number of nodes, the number of links, correlations between the nodes and the links, and values of the weights granted to the respective links in the neural network. For example, when the same number of nodes and links exist and there are two neural networks in which the weight values of the links are different from each other, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed through for reaching the corresponding node from the initial input node. However, a definition of the layer is predetermined for description and the order of the layer in the neural network may be defined by a method different from the aforementioned method. For example, the layers of the nodes may be defined by the distance from a final output node.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean nodes constituting the neural network other than the initial input node and the final output node.

In the neural network according to an exemplary embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes decreases from the input layer to the hidden layer. Further, in the neural network according to yet another exemplary embodiment of the present disclosure, the number of nodes of the input layer may be larger than the number of nodes of the output layer, and the neural network may be a neural network of a type in which the number of nodes increases from the input layer to the hidden layer. The neural network according to still yet another exemplary embodiment of the present disclosure may be a neural network of a type in which the neural networks are combined.

A deep neural network (DNN) may refer to a neural network that includes a plurality of hidden layers in addition to the input and output layers. When the deep neural network is used, the latent structures of data may be determined. That is, latent structures of photos, text, video, voice, and music (e.g., what objects are in the photo, what the content and feelings of the text are, what the content and feelings of the voice are) may be determined. The deep neural network may include a convolutional neural network (CNN), a recurrent neural network (RNN), an auto encoder, generative adversarial networks (GAN), a restricted Boltzmann machine (RBM), a deep belief network (DBN), a Q network, a U network, a Siam network, a Generative Adversarial Network (GAN), and the like. The description of the deep neural network described above is just an example and the present disclosure is not limited thereto.

In an exemplary embodiment of the present disclosure, the network function may include the auto encoder. The auto encoder may be a kind of artificial neural network for outputting output data similar to input data. The auto encoder may include at least one hidden layer and odd hidden layers may be disposed between the input and output layers. The number of nodes in each layer may be reduced from the number of nodes in the input layer to an intermediate layer called a bottleneck layer (encoding), and then expanded symmetrical to reduction to the output layer (symmetrical to the input layer) in the bottleneck layer. The auto encoder may perform non-linear dimensional reduction. The number of input and output layers may correspond to a dimension after preprocessing the input data. The auto encoder structure may have a structure in which the number of nodes in the hidden layer included in the encoder decreases as a distance from the input layer increases. When the number of nodes in the bottleneck layer (a layer having a smallest number of nodes positioned between an encoder and a decoder) is too small, a sufficient amount of information may not be delivered, and as a result, the number of nodes in the bottleneck layer may be maintained to be a specific number or more (e.g., half of the input layers or more).

The neural network may be trained in a direction to minimize errors of an output. Details regarding the reinforcement learning method of the neural network will be elaborated later. The training of the neural network is a process of repeatedly inputting training data into the neural network and calculating the output of the neural network for the training data and the error of a target and back-propagating the errors of the neural network from the output layer of the neural network toward the input layer in a direction to reduce the errors to update the weight of each node of the neural network A variation amount of the updated connection weight of each node may be determined according to a learning rate. Calculation of the neural network for the input data and the back-propagation of the error may constitute a training cycle (epoch). The learning rate may be applied differently according to the number of repetition times of the training cycle of the neural network. For example, in an initial stage of the training of the neural network, the neural network ensures a certain level of performance quickly by using a high learning rate, thereby increasing efficiency and uses a low learning rate in a latter stage of the training, thereby increasing accuracy.

Before describing a method of determining a valid working spot of a robot according to an exemplary embodiment of the present disclosure, an example of a “process for generating a robotic process program” to which the present disclosure may be applied is described briefly.

The process of generating a robotic process program may be roughly divided into two parts: \textcircled{a} “a process of distributing working spots for each robot to perform work” and \textcircled{b} “a process of determining a work path and a work sequence of a robot for each robot”. In this case, it is obvious that when the \textcircled{a} and \textcircled{b} processes are performed by simply considering the number of all cases, the number of cases to be considered (that is, a search space) is so large that it would be the most inefficient in terms of time and cost. This is because the \textcircled{a} process takes into account the number of stations, the number of robots, the number of joints that each robot includes, and the number of working spots that need to be worked on, and the \textcircled{b} process takes into account both the working spots distributed by the \textcircled{a} process and the interactions between the robots (for example, collisions), which exponentially increases the amount of computation required.

On the other hand, when the method according to the exemplary embodiment of the present disclosure is used in advance of performing the \textcircled{a} and \textcircled{b} processes, the search space to be considered in both the \textcircled{a} and \textcircled{b} processes may be effectively reduced, which may significantly save computational resources and turn the \textcircled{a} and \textcircled{b} processes (which are a Non-deterministic Polynomial Hard (NP Hard) problems) into “problems that can be optimized in a feasible time”.

For example, prior to distributing working spots among the robots, the present disclosure may generate “valid working spots” that exclude working spots at which when each robot works, efficiency extremely deteriorates or working is impossible, and may efficiently reduce the “search space for working spot distribution (working spot distribution among the robots)” by considering each robot's valid working spots. In terms of the effect, the amount of computation required to generate a program may be reduced by reducing the search space to be considered in subsequent operations (for example, the \textcircled{a} and \textcircled{b} processes). For example, based on a random tree model, a genetic model (GA model), a neural network model that performs reinforcement learning, and the like, the amount of computation of the random tree model, the genetic model, the neural network model, and the like may be significantly reduced when implementing the subsequent operations (for example, the \textcircled{a} and \textcircled{b} processes). However, this is an example of one of the various situations to which the present disclosure may be applied and the present disclosure is not limited thereto.

Hereinafter, an outlined process of a method of determining a valid working spot of a robot according to an exemplary embodiment of the present disclosure will be described with reference to operations S300 to S320 of FIG. 3.

First, the method according to the exemplary embodiment of the present disclosure will be outlined with reference to FIG. 3. The method may include: “identifying, by the processor 110, a working spot” (operation S300), “determining, by the processor 110, whether a robot is capable of taking at least one pose for working the working spot” (operation S310), “when the robot is capable of taking at least one pose for working the working spot, determining, by the processor 110, the working spot as a valid working spot of the robot” (operation S320), and “generating a search space for distributing working spots based on the valid working spot of the robot” (operation S330).

Before describing each operation in detail, it is noted that throughout the present disclosure, including operations S300 to S330 above, “robot” is often used in expressions that may be understood as singular for ease of presentation, nonetheless, a robot may be understood as a concept encompassing a plurality of robots rather than a single entity, or a plurality of robots including robots of different types. For example, referring to operation S300, it is disclosed that the processor 110 identifies valid working spots for the robot based on analyzing the pose of the robot, but the robot is not limited to a single entity and may refer to each of a plurality of robots. In other words, it may be understood to identify valid working spots for each of the plurality of robots based on analyzing the respective poses of the plurality of robots.

Also, throughout the present disclosure, a “station” is a mid-level process unit that includes one or more robots and may be generated based on a variety of criteria (location, working type, and the like). For example, robots clustered in a specific location in a factory may form one station, or robots performing the same type of work may form one station. In other words, the entire robotic process may be divided into a plurality of stations, and each of the plurality of stations may include one or more robots.

Hereinafter, an exemplary embodiment of each of operations S300 to S330 will be disclosed.

First, operation S300 is “identifying a working spot”, in which the working spot may generally refer to any point on a work target that the robot needs to reach and perform work. The work may include actions that can be performed by a robot, such as assembling, moving, cutting, joining, bonding, drilling, sanding, painting, heat treating, welding, etc.

In one exemplary embodiment of operation S300, the processor 110 may perform operation S300-1 of identifying location information of the working spot, and operation S300-2 of identifying work direction information of the working spot. For example, the processor 110 may identify location information indicating a specific location of a working spot (for example, a location at which welding is to be performed), and work direction information indicating a direction in which the work is to be performed at the working spot (for example, an angle at which the welding is to be made at the working spot). In the exemplary embodiment, the processor 110 may determine a “valid working spot of the robot” based on “whether the corresponding robot is capable of reaching the location of the working spot” or “whether the corresponding robot is capable of working according to the workable direction information.” For example, when the robot is unable to reach the location of the working spot, or when the robot is unable to work with the workable direction information, the working spot may be excluded from the valid working spot of the robot. Of course, it is obvious that when the robot is unable to reach the location of the working spot, it is impossible for the robot to work with the workable direction information.

Following operation S300, operation S310, which may be performed by processor 110, is “determining whether the robot is capable of taking at least one pose for working the working spot.” The purpose of operation S310 is to ensure that, as each robot works, valid working spots are generated based on the excluded working spots, excluding working spots that are highly inefficient or impossible to work on.

In the exemplary embodiment, “at least one pose for the robot to work a specific working spot” may be “a valid pose by an inverse kinematics algorithm”. For example, the processor 110 may determine that “the specific robot is capable of taking at least one pose to create the specific working spot” when it is determined that based on an Inverse Kinematics (IK) analysis, the specific robot is capable of moving its work part to the location of the specific working spot. For example, the processor 110 may determine that “the specific robot is capable of taking at least one pose to generate the specific working spot” when it is determined that based on an Inverse Kinematics (IK) analysis, the specific robot is capable of moving its work part to the location of the specific working spot, and at the same time the specific robot is capable of taking a motion consistent with the work direction information at the specific working spot.

Alternatively, “at least one pose for the robot to work on a specific working spot” may be limited to “a pose that is valid by the inverse kinematics algorithm and, at the same time, does not have a risk of collision during the work process”. As a relevant exemplary embodiment, operation S310 may include: operation S310-1 of identifying, by the processor 110, a pose by which the robot is able to position a working part of the robot at the working spot”, “operation S310-2 of determining, by the processor 110, whether the identified pose causes a collision”, and “operation S310-3 of searching for, by the processor 110, a new pose based on the identified pose when the identified pose causes a collision”. For example, the processor 110 may determine whether the robot is capable of taking “the pose that is valid by the inverse kinematics algorithm and at the same time does not have the risk of collision during the work process” by considering location information (for example, 3D Cartesian coordinates) and work direction information of the specific working spot, and only when the robot is capable of taking the pose, the processor 110 may determine the specific working spot to be a valid working spot in the subsequent operation.

In a further exemplary embodiment, operation S310-3 of searching a new pose based on the identified pose when the identified pose causes the collision may perform at least one of \textcircled{1} “performing, by the processor 110, an IK computation while rotating the working part of the robot about a specific axis direction of the robot”, \textcircled{2} “performing, by the processor 110, an IK computation while causing the working part of the robot to make a translational movement in a specific axis direction of the robot”; and \textcircled{3} “performing, by the processor 110, an IK computation while changing a working direction of the working part of the robot”. For example, the processor 110 may search for additional poses by performing a change action (that is, at least one of operations \textcircled{1}, \textcircled{2}, and \textcircled{3}) in the specific pose when the specific pose of the robot is valid by the IK computation but is likely to cause a collision. In this case, as an example of operations \textcircled{1}, \textcircled{2}, and \textcircled{3}, operation \textcircled{1} may perform a change operation to rotate the robot (or a partial structure of the robot) about a specific local axis (for example, the z-axis) in the specific pose, and perform the IK computation to search additional poses. In operation \textcircled{2}, the processor 110 may perform a change operation to translationally move the robot (or a partial structure of the robot) in the specific pose in the direction of the specific local axis (for example, z-axis), and perform the IK computation to search for additional poses. In this case, the translational movement may be performed with an offset of 0.01 units from 0 to 0.01 m. In operation \textcircled{3}, the processor 110 may perform a change operation to change the working direction of the robot (or a partial structure of the robot) in the specific pose, and perform the IK computation to search for additional poses. On the other hand, in this case, the change of the work direction may be a change of flipping 180 degrees in the opposite direction with respect to the specific local axis (for example, the z-axis).

Following operation S310, operation S320, which may be performed by the processor 110, is the operation of “determining the working spot as a valid working spot of the robot, when the robot is capable of taking at least one pose for working the working spot.” The purpose of operation S320 is to ensure that, when each robot works, valid working spots are generated based on the excluded working spots, excluding working spots that are highly inefficient or impossible to work on. In terms of the effect, operation S300 may reduce the search space to be considered in subsequent operations. Specifically, during the work spot distribution (the work spot distribution between the robots), the search space may be reduced in such a way that not all working spots are searched for each robot, but only the valid working spots uniquely determined for each robot are searched.

Such operation 320 may include “determining at least one candidate working pose associated with the valid working spot based on the at least one pose” (operation S320-1). That is, when the robot is capable of taking at least one pose for working the working spot, the processor 110 may determine \textcircled{1} the working spot as a “valid working spot of the robot”, and \textcircled{2} at the same time, determine the at least one pose as “at least one candidate working pose of the robot associated with the valid working spot”. On the other hand, when a specific robot has multiple candidate working poses for a specific valid working spot, the search space may still be large because multiple candidate working poses need be searched in relation to a single working spot, even though the search space is reduced in terms of the number of working spots. Thus, according to one exemplary embodiment of the present disclosure, the processor 110 may perform operations to limit the number of candidate working poses associated with a specific valid working spot of a specific robot.

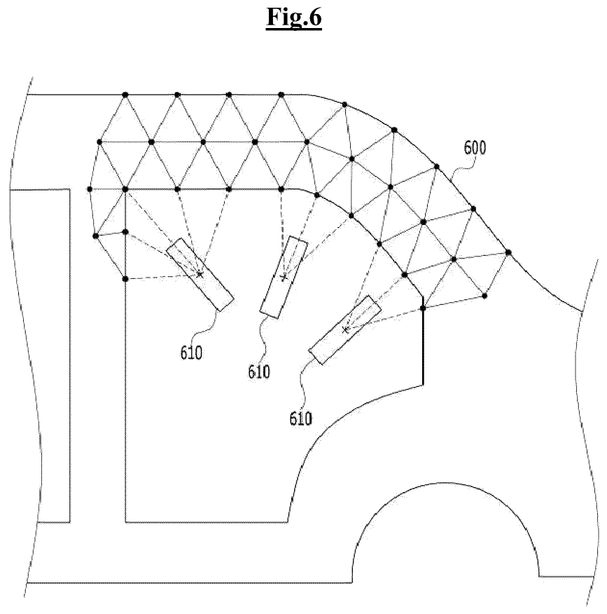

In one exemplary embodiment, the processor 110 may evaluate a plurality of candidate working poses for each valid working spot by utilizing predetermined criteria for selecting the optimum candidate working poses, and may determine equal to or fewer than a predetermined number of candidate working poses for each valid working spot based on the evaluation. Specifically, “the processor 110 may utilize at least one of \textcircled{a} “distance information to the center of gravity of the work target,” \textcircled{b} “angle information between the axis of the work target and the axis of the robot,” and \textcircled{c} “distance information between the center of gravity of the robot and a mesh vertex of the work target” as a predetermined criterion, and may determine equal to or fewer than the predetermined number of candidate working poses for each valid working spot based on the information. For example, referring to FIG. 4, in one exemplary embodiment using the \textcircled{a} information, the processor 110 may give high priority to candidate working poses that maximize as much as possible the distance between the center of mass 410 of the robot (or a partial structure of the robot, the center of mass of a tool used by the robot) and the center of mass 401 of the work target. This is because, when the optimum candidate working poses are selected based on the criteria, the selected candidate working poses may be compatible with the valid working spots at similar locations, which may help in the future when distributing target working spots to the robots or optimizing the paths of the robots. Next, referring to FIG. 5, in one exemplary embodiment using the \textcircled{b} information, the processor 110 may utilize “angle information between a global axis of a work target 500 and a local axis of a robot 510.” Specifically, the processor 110 may select optimized candidate working poses based on angle information between a “set global axis (for example, an x-axis or y-axis relative to the work target 500 illustrated in FIG. 5) oriented from the inside to the outside of the work target 500” and a “specific local axis of the robot 510 (for example, an x-axis of the robot 510 or a y-axis of the robot 510 illustrated in FIG. 5).” This is because, when the optimum candidate working poses are selected based on the criteria, similar candidate working poses may be selected for valid working spots that exist on the same side of the work target, which may help in the process of distributing target working spots to the robots or optimizing the paths of the robots in the future. Next, referring to FIG. 6, in one exemplary embodiment using the \textcircled{c} information, the processor 110 may give high priority to candidate working poses that may maximize as much as possible the distance between “the center of mass of a robot 610 (or the center of mass of work equipment of the robot 610)” and “the mesh vertex that is closest to the center of mass of the robot, among mesh vertices 600 of a work target.” This is because, when the optimum candidate working poses are selected based on the criteria, the candidate working poses with the secured stability may be selected and the risk of collisions may be reduced, which may help in the process of distributing target working spots to the robots or optimizing the paths of the robots in the future.

On the other hand, in relation to operation S320, there may occur the case where the robot is unable to enter the working spot, even though the robot has at least one candidate pose for working the working spot. In this regard, it is obvious that a robot that cannot enter a specific working spot cannot work on the specific working spot. Thus, as a further exemplary embodiment of this situation, the operation S320 may include “excluding a specific working spot from a valid working spot when the processor 110 predicts that the robot cannot enter the working spot, although the robot is capable of taking at least one pose for working the working spot” (S320-2). For example, when it is predicted that the robot is unable to enter the specific working spot due to a narrow passage available for entry or a collision upon entry, the specific working spot may be excluded from the group of valid working spots of the robot, even if it is simulated that the robot is capable of taking the pose to perform the specific work. Further, in the case where the angle at which the robot is capable of moving is limited in advance to prevent delay due to excessive movement, when the robot can take a pose to work on a specific working spot but cannot enter the specific working spot within the limited angle range, the specific working spot may also be excluded from the group of valid working spots of the robot.

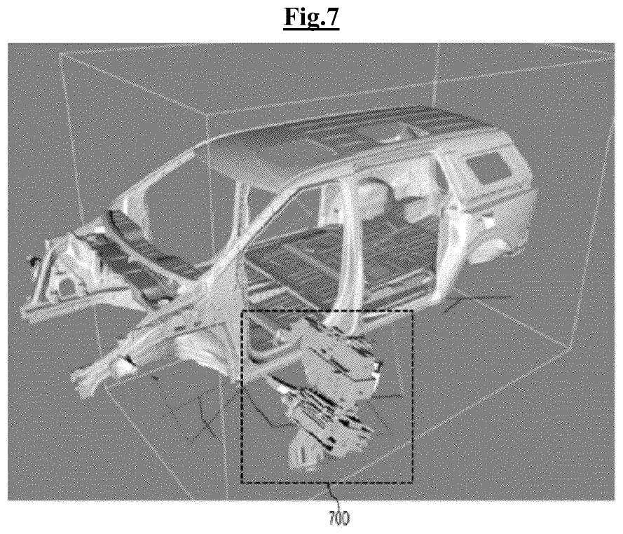

In one exemplary embodiment, “predicting whether the robot is able to enter the working spot” may be performed based on approximating the movement of the robot to the movement of the robot's work part. For example, this method may be usefully used in terms of computational efficiency, as this method requires the much less computation amount compared to utilizing the structure of the entire robot. In one exemplary embodiment, the partial structure of the robot may include a welding gun 700, which is one of the tools that may be mounted on a robot, such as a robot 700 in FIG. 7. In this case, the welding gun 700 is an example and the tool is not limited to a welding gun. In the aspect of the effect, when “using the entirety of the robot including the plurality of joints to predict whether the robot can enter” is compared with “performing the approximation based on the partial structure of the robot, such as a welder, to predict whether the robot can enter”, the amount of computation required in the latter case may be significantly reduced. Furthermore, since the case where “the approximated partial structure of the robot cannot enter” naturally corresponds to the case where “the (more complex) actual structure of the robot also cannot enter”, the case where “the robot cannot enter” can be accurately predicted even with such the approximation, and the reduction of the searching space can be accurately performed based on this.

Following operation S320, operation S330, which may be performed by the processor 110, is the operation of “generating a search space for working spot distribution based on the valid working spot of the robot.” The purpose of operation S320 is to generate an optimized search space to be used in the programming of the robotic process, based on the valid working spots and the candidate working poses of the respective robots generated in the previous operation.

In one exemplary embodiment, the processor 110 may perform, in connection with operation S330, an operation of “generating a search space for distributing working spots based on the valid working spots of the robot and the at least one candidate working pose.” Further, in connection with the operation, the processor 110 may perform operation S330-1 of “excluding the working spots that are not valid working spots of the robot among total working spots from the search space associated with the robot” and operation S330-2 of “limiting the at least one candidate working pose to a predetermined number or less”. As an illustrative example, the processor 110 may identify a valid working spot for each of the robots, based on whether each “robot r” is capable of taking a “pose p” to perform work at a “specific working spot s”. Additionally, the processor 110 may generate [r, s, p] that is “robot identification information—valid working spot information—candidate pose information” in association with the valid working spot of each robot. In the exemplary embodiment, r may correspond to identification information of a specific robot (for example, the 10^{th} robot), s may correspond to identification information of one valid working spot (for example, the 130^{th} working spot) among the valid working spots of the specific robot, and p may correspond to one or more candidate pose information associated with the one valid working spot (for example, information of one or more of an A pose, a B pose, and a C pose that the 10^{th} robot may take in association with the 130^{th} working spot). In this case, the one or more candidate pose information may be limited to include only equal to or fewer than a predetermined number of the poses. For example, when a specific robot (for example, the 10^{th} robot) is capable of working in 10 candidate poses (for example, an A pose to a J pose) at one valid working spot (for example, the 130^{th} working spot) among the valid working spots of the specific robot, the 3 optimum candidate poses may be selected from among the 10 candidate poses so that only the 3 selected candidate poses are included in the search space. In one exemplary embodiment, the processor 110 may evaluate a plurality of candidate working poses for each valid working spot by utilizing predetermined criteria for selecting the optimum candidate working poses, as described above, and may select equal to or fewer than a predetermined number of candidate working poses (for example, three candidate working poses) for each valid working spot based on the evaluation. Specifically, “the processor 110 may utilize at least one of (a) “distance information to the center of gravity of the work target,” \textcircled{b} “angle information between the axis of the work target and the axis of the robot,” and \textcircled{c} “distance information between the center of gravity of the robot and a mesh vertex of the work target” as a predetermined criterion, and may determine equal to or fewer than the predetermined number of candidate working poses for each valid working spot based on the information. In an effect aspect, the above exemplary embodiment may have the effect that the number of candidate working poses may be adjusted in advance, thereby limiting in advance the amount of computation that may occur when the processor 110 has a limited amount of computation available.

In addition, the operations included in the exemplary embodiments discussed above may be implemented based on computations utilizing a neural network model. For example, as discussed above, the determination of valid working spots, the determination of candidate working poses, the selection of the optimal candidate working poses, the analysis of the movement path of the robot, and the generation of the search space may be performed based on a neural network model. In addition, the distribution of working spots among the robots in the entire process, and the determination of the movement path or movement order of each robot may be implemented by a neural network model based on reinforcement learning.

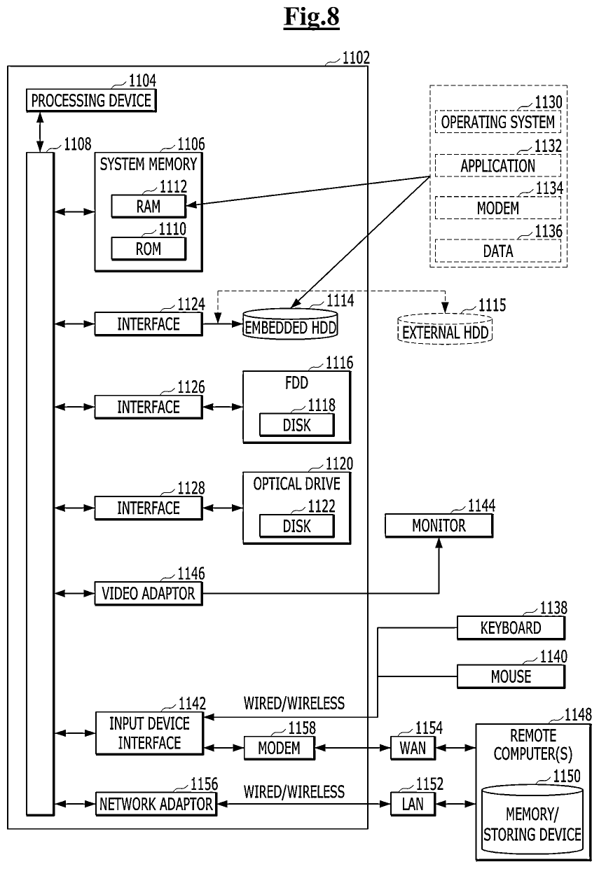

FIG. 8 is a normal and schematic view of an exemplary computing environment in which the exemplary embodiments of the present disclosure may be implemented.

It is described above that the present disclosure may be generally implemented by the computing device, but those skilled in the art will well know that the present disclosure may be implemented in association with a computer executable command which may be executed on one or more computers and/or in combination with other program modules and/or a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure. Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11(a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various exemplary embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is coherent with the principles and new features presented herein.

1. A method of determining a valid working spot of a robot, the method performed by a computing device, the method comprising:
identifying a working spot;
determining whether a robot is capable of taking at least one pose for working the working spot;
when the robot is capable of taking at least one pose for working the working spot, determining the working spot as a valid working spot of the robot; and
generating a search space for distributing working spots based on the valid working spot of the robot,
wherein the determining of the working spot as the valid working spot of the robot when the robot is capable of taking at least one pose for working the working spot includes:
determining at least one candidate working pose associated with the valid working spot based on the at least one pose; and
evaluating at least one candidate working pose associated with the valid working spot by utilizing predetermined criteria and determining candidate working poses equal to or fewer than a predetermined number of candidate working poses based on an evaluation result,
wherein the evaluating at least one candidate working pose associated with the valid working spot by utilizing predetermined criteria and determining the candidate working poses equal to or fewer than the predetermined number of candidate working poses based on an evaluation result includes determining the candidate working poses equal to or fewer than the predetermined number of candidate working poses by using at least one of:
distance information to a center of mass of a work target;
angle information between an axis of the work target and an axis of the robot; or
distance information between a center of mass of the robot and a mesh vertex of the work target.

2. The method of claim 1, wherein the identifying of the working spot includes:
identifying location information of the working spot; and
identifying work direction information of the working spot.

3. The method of claim 1, wherein the determining of whether the robot is capable of taking at least one pose for working the working spot includes:
identifying a pose in which the robot is capable of positioning a working part of the robot at the working spot;
checking whether the identified pose causes a collision; and
when the identified pose causes a collision, searching for a new pose based on the identified pose.

4. The method of claim 3, wherein the searching for the new pose based on the identified pose includes at least one of:
performing an Inverse Kinematics (IK) computation while rotating a work part of the robot about a specific axis direction of the robot;
performing an IK computation while translationally moving a working part of the robot in a specific axis direction of the robot; or
performing an IK computation while changing a working direction of a working part of the robot.

5. (canceled)

6. (canceled)

7. The method of claim 1, wherein the generating of the search space for distributing the working spots includes:
generating a search space for distributing working spots based on the valid working spot of the robot and the at least one candidate working pose.

8. The method of claim 7, wherein the generating of the search space for distributing the working spots based on the valid working spot of the robot and the at least one candidate working pose includes:
excluding working spots that are not valid working spots of the robot among total working spots from the search space associated with the robot; and
limiting the at least one candidate working pose to a predetermined number or less.

9. The method of claim 1, wherein the determining of the working spot as the valid working spot of the robot when the robot is capable of taking at least one pose for working the working spot includes:
excluding a predicted specific working spot from the valid working spot when the robot is predicted to be unable to enter the working spot although the robot is capable of taking at least one pose for working the working spot.

10. The method of claim 9, wherein the predicting of whether the robot is able to enter the working spot is performed based on approximating a movement of the robot to a movement of a work part of the robot.

11. A computer program stored in a non-transitory computer-readable storage medium, the computer program causing at least one processor to perform operations to determine a valid working spot of a robot, the operations comprising:
an operation of identifying a working spot;
an operation of determining whether a robot is capable of taking at least one pose for working the working spot;
an operation of determining the working spot as a valid working spot of the robot, when the robot is capable of taking at least one pose for working the working spot; and
an operation of generating a search space for distributing working spots based on the valid working spot of the robot,
wherein the operation of determining of the working spot as the valid working spot of the robot when the robot is capable of taking at least one pose for working the working spot includes:
an operation of determining at least one candidate working pose associated with the valid working spot based on the at least one pose; and
an operation of evaluating at least one candidate working pose associated with the valid working spot by utilizing predetermined criteria and determining candidate working poses equal to or fewer than a predetermined number of candidate working poses based on an evaluation result,
wherein the operation of evaluating at least one candidate working pose associated with the valid working spot by utilizing predetermined criteria and determining the candidate working poses equal to or fewer than the predetermined number of candidate working poses based on an evaluation result includes:
an operation of determining the candidate working poses equal to or fewer than the predetermined number of candidate working poses by using at least one of:
distance information to a center of mass of a work target;
angle information between an axis of the work target and an axis of the robot; or
distance information between a center of mass of the robot and a mesh vertex of the work target.

12. A computing device, comprising:
at least one processor; and
a memory,
wherein the at least one processor is configured to:
identify a working spot,
determine whether a robot is capable of taking at least one pose for working the working spot,
determine the working spot as a valid working spot of the robot when the robot is capable of taking at least one pose for working the working spot, and
generate a search space for distributing working spots based on the valid working spot of the robot,
wherein the determining of the working spot as the valid working spot of the robot when the robot is capable of taking at least one pose for working the working spot includes:
determining at least one candidate working pose associated with the valid working spot based on the at least one pose; and
evaluating at least one candidate working pose associated with the valid working spot by utilizing predetermined criteria and determining candidate working poses equal to or fewer than a predetermined number of candidate working poses based on an evaluation result,
wherein the evaluating at least one candidate working pose associated with the valid working spot by utilizing predetermined criteria and determining the candidate working poses equal to or fewer than the predetermined number of candidate working poses based on an evaluation result includes determining the candidate working poses equal to or fewer than the predetermined number of candidate working poses by using at least one of:
distance information to a center of mass of a work target;
angle information between an axis of the work target and an axis of the robot; or
distance information between a center of mass of the robot and a mesh vertex of the work target.
